(19) United States
(12) Patent Application Publication
(10) Pub. No.: US 2005/0069652 A1
(43) Pub. Date: Mar. 31, 2005

(54) Method for coating an object with a film and equipment therefor

(76) Inventors: Jean-Philippe Allen, Hauts Sablons (FR); Maurice Bergougnou, Ontario (CA); Ion Inculet, Ontario (CA); Nicolas Pierru, Marly La Ville (FR)

Correspondence Address: Thomas F Roland;Atofina Chemical Inc, 26th Floor, 2000 Market Street, Philadelphia, PA, 19103, US

(21) Appl. No.: 10/496,816

(22) PCT Filed: Nov. 29, 2002
(86) PCT No.: PCT/FR02/04109

(30) Foreign Application Priority Data
Nov. 29, 2001 (FR) 0115439
May 3, 2002 (FR) 02055554

(51) Int. Cl. B05D 1/22

(52) U.S. Cl. 427/459

(57) ABSTRACT

The present invention is a method for covering an object with a film resulting from the melting of a thin layer of powder, in which method comprises: (a) having a bed of electrified fluidized powder in a tank, this powder being charged by a forced-circulation tribocharging device; (b) dipping the object, connected to zero or sufficient potential, into the tank in order to cover it with powder; (c) placing the object, covered with the powder, in an oven at a temperature high enough to obtain the coating film by melting the powder. According to one advantageous embodiment of the invention, the oven includes electrodes raised to a high electrical potential so as to cause a corona effect which compensates for the relaxation of the charge on the powder particles while they are being heated. The charge on the particles is maintained and therefore they remain on the object and thus can form the film by melting. The present invention also relates to the apparatus for implementing the method.

This application claims benefit, under U.S.C. §119 or §365 of French Application Numbers FR 01.15439, filed Nov. 29, 2001, and FR 02.055554 filed May 3, 2002; and PCT/FR02/04109 filed Nov. 29, 2002.

### FIELD OF THE INVENTION

The present invention relates to a method for covering an object with a film resulting from the melting of a thin layer of powder previously deposited on the object and to the apparatus for implementing this method.

### BACKGROUND OF THE INVENTION

There are currently a number of coating methods in existence on an industrial scale.

The first is electrostatic powder coating; this consists in charging the powder with static electricity and bringing it into contact with the object that is to be covered, which object is connected to zero potential. For example, the powder is injected into an electrostatic spray gun which will charge the said powder by the corona effect or by triboelectrification, or by a combination of the two. The powder thus charged is sprayed onto the object to be covered, which object is connected to zero potential. According to another form of electrostatic powder coating, the object connected to zero potential is dipped into a fluidized bed of charged powder. Within the fluidized bed is the powder with which it is wished to cover the object. This powder is in the form of small solid particles, for example particles between 0.01 and 1 mm in size, and of any shape, which are in a state of fluidity within the bed in the presence of air or any other gas. Within the fluidized bed there are electrodes for charging the powder by the corona effect or a device for charging it by the triboelectric effect. The object covered with powder is then placed in an oven at a temperature high enough to ensure that a coating forms by melting the powder, causing it to form a film. For example, for a nylon-11 powder it is necessary to heat to 220° C.

The second method consists in preheating the object that is to be covered to a temperature above the melting point of the powder. Once hot, the object is immediately immersed in a fluidized bed of the powder; the powder melts on contact with the hot object and forms a film. A solid covering is thus ensured. In this method, a hot object is dipped into a cold fluidized bed and in order to combat heat loss it is necessary to have an oven at a temperature which is higher than the temperature required for film forming, this leading to increased energy consumption. In addition, if the object consists of parts differing very greatly in thermal inertia, these various parts do not have the same temperature and therefore the thickness of the film is not uniform.

The present invention relates to the electrostatic method in which the object is dipped into a fluidized bed of charged powder.

Patent U.S. Pat. No. 3,248,253 describes electrostatic fluidized beds in which electrodes raised to very high potentials are placed. In such electrostatic fluidized beds, the particles are charged by the corona effect, which consists in ionizing the air in the vicinity of a spike and therefore in electrically charging the particles in this region. The objects to be coated held on a conveying system and connected to earth pass over the fluidized bed and are covered with powder by electrostatic attraction. According to a variant, the objects to be coated are immersed in the fluidized bed.

A similar method is described in patent U.S. Pat. No. 4,381,728. Good coverage is obtained in such beds but there is a certain danger associated with the presence of electrodes raised to high potential which may give rise to electrical arcs with the object that is to be covered.

To avoid any electrical arcing between the electrode and the object that is to be coated, it is possible to place this electrode under a porous slab as described in patent GB 1,487,195.

One drawback with these conventional corona-charged electrostatic fluidized bed systems lies in the fact that the deposition of powder is not uniform. In particular, the concave parts of an article are difficult to access. Patent U.S. Pat. No. 4,689,241 describes limitations such as insufficient thicknesses in the Faraday cages formed by the object that is to be covered. Finally, a difference in thickness of the powder deposit is observed between the parts furthest from the charging electrode. Other descriptions of conventional corona-effect electrostatic fluidized beds are to be found in “Electrostatic fluidized bed, theory, design, application”, American Paint Journal 1972, 57(11) 53-5, 66, 68, 70-2 and in “ANTEC, Conference Proceedings (Part 2)”, Society of Plastics Engineers, 1994—Brookfield, Conn., USA—page 2329, 2331.

Alternative solutions have been proposed in response to these problems. Patent WO 96/11061 describes a charging system which does not use a corona effect but which works by induction. However, this technique is still applicable only to powders of low resistivity.

The publication “Triboelectrification of polymer powders in a fluidized bed”, Power Engineering; Journal of the Academy of Science of the USSR, Vol. 19, No. 6, page 75-83, describes a triboelectric charging system, but which is nonetheless assisted by electrodes connected to a high voltage.

The publication “Charge of powdered paint according to a triboelectric mechanism during its fluidization”, Journal Lakokras, Mater. IKH Primen (1979), (4), 30-2, describes triboelectric charging in a conventional fluidized bed on the walls of the tank. However, it discloses the limitations of the electrical charge over time on account of powder particles covering the walls from as early as the first moments of fluidization.

Patent U.S. Pat. No. 6,506,455 describes a method for covering an object with a film resulting from the melting of a thin layer of powder, in which method:
(a) use is made of a bed of electrified fluidized powder in a tank, this powder being charged essentially by a tribocharging device other than the walls of the tank and located in the tank and/or outside the tank,
(b) the object, connected to zero or sufficient potential, is dipped into the tank in order to cover it with powder,
(c) the object, covered with the powder, is then placed in an oven at a temperature high enough to obtain the coating film by melting the powder.

This is an electrostatic fluidized bed tribocharged essentially using a device other than the walls of the tank. The powder is tribocharged; a high volumetric charge density is thus created within the fluidized bed. The powder is charged and fluidized. If an object that is to be covered, connected to zero or sufficient potential, is immersed into the charged bed, there will be an electric field created by the volume of charged powder. This will contribute to good electrodeposition on the earthed object. The object may be at a positive, negative or zero bias.

In this invention, the powder is tribocharged, that is to say charged by contact or friction. Friction is provided by the fluidization air or gas which carries the powder particles and allows them to come into contact with the tribocharging systems which will be described hereinafter. The charging system described in the present application is autonomous and requires no supply of energy other than the gas used to fluidize the powder.

Advantageously, a “honeycomb” is used as tribocharging device. This is a structure made up of geometric elements the cross section of which may range from any kind of polygon (the elements are then prisms) to a circle (the elements are then tubes). These elements are hollow, are placed vertically and have a thickness preferably of between 1 and 10 mm; their length is, for example, between 15 and 25 cm. These tubes are stuck together to form a solid and uniform assembly. The gaps between tubes are plugged by any means such as sheets of aluminium. Although any kind of polygonal cross section may be envisaged, the cylindrical structure is preferable. A cylindrical geometry is preferred in order to allow uniform fluidization. Edge effects will be limited by an appropriate length of the tubes which make up the honeycomb, that is to say that these tubes are advantageously more than 15 cm long.

This “honeycomb” is placed at the bottom of the bed. It is necessary to leave enough space above the bed for immersing the object and to place around the said object a volume charge density sufficient to ensure electrodeposition.

The “honeycomb” is placed as low down in the bed as possible, so as to optimize contact in the tubes without, however, disturbing fluidization.

The diameter of the tubes is chosen to be as small as possible so as to increase the contact area, but it is nonetheless necessary to make sure that the tubes will not become clogged and that they are therefore wide enough to allow correct fluidization. The longer these tubes, the better the electric charge generated on the powder particles will be, although limitations are imposed due to the space that has to be left for dipping the article. By way of example, tubes 25 mm in diameter and 150 mm in length may be used. Advantageously, they are made of PVC or PTFE.

The method, based on the honeycomb in the fluidized bed described in this patent U.S. Pat. No. 6,506,455, has the advantage of being very simple and very economical in terms of energy since it does not have electrodes connected to a potential; however, the charging of the particles is not always perfect. It has now been found that, using a forced-circulation tribocharging tube, the powder particles are charged very well. The term “forced circulation” is employed as opposed to circulation in the tubes of the honeycomb, which only occurs by the flow of the gas for fluidizing the bed. The term “forced circulation” is understood to mean that part of the contents of the fluidized bed, that is to say a mixture of fluidizing gas and powder, is drawn off, with the aid of a pump or an equivalent device, such as a gas ejector (preferably operating with the same gas as the fluidized bed), passes through one or more tribocharging tubes. Preferably, the pump and the tribocharging tube are outside the bed in order not to disturb its operation; the gas and the tribocharged powder, after having passed through the tribocharging tube, are returned to the fluidized bed. The principle of tribocharging powders using a gun, in which the powder to be charged is made to flow owing to the effect of a gas stream is known from patent U.S. Pat. No. 4,399,945. The particles charge up by friction on a surface, an earthing system allowing the charges to be removed. However, in this prior art, it is neither described nor suggested that the powder comes from a fluidized bed and is returned thereto after having been charged. Patent U.S. Pat. No. 5,622,313 describes an improvement to the above patent, that is to say that, in order to remove the charges from the tribocharging surface, it is treated by the corona effect. The charges provided by the corona effect not only neutralize the charges that have built up on the tribocharging surface but also pass into the powder and therefore add to the charges created by the triboelectric effect. As in the patent U.S. Pat. No. 4,399,945, it is neither described nor suggested that the powder comes from a fluidized bed and is returned thereto after having been charged.

The object having been covered with powder is removed from the fluidized bed and heated so that the powder melts and forms a film on the object. As soon as the object covered with powder starts to be heated, a relaxation of the charges occurs and, depending on the nature of the powder, the nature of the object to be covered and its geometry, some of the powder may become detached before having melted and formed the film. It has now been found that all that is required is to place electrodes in the oven, these electrodes being raised to a high electrical potential so as to cause a corona effect which compensates for the relaxation of the charge on the powder particles while they are being heated. The charge on the particles is therefore maintained and they therefore remain on the object and can thus form the film by melting. This has not been described in the prior art. In the prior art U.S. Pat. No. 3,248,253, the corona effect is used to electrically charge the powder in the bed, whereas in the present invention the powder has been tribocharged and has been deposited on the object, and the corona effect is used only to keep the powder on the object while it melts to form the film.

### SUMMARY OF THE INVENTION

The present invention is a method for covering an object with a film resulting from the melting of a thin layer of powder, in which method comprises:
(a) having a bed of electrified fluidized powder in a tank, this powder being charged by a forced-circulation tribocharging device;
(b) dipping the object, connected to zero or sufficient potential, into the tank in order to cover it with powder;
(c) placing the object, covered with the powder, in an oven at a temperature high enough to obtain the coating film by melting the powder.
(c)

According to one advantageous embodiment of the invention, the oven includes electrodes raised to a high electrical potential so as to cause a corona effect which compensates for the relaxation of the charge on the powder particles while they are being heated. The charge on the particles is maintained and therefore they remain on the object and thus can form the film by melting.

The present invention also relates to the apparatus for implementing the method.

### BRIEF DESCRIPTION OF THE DRAWINGS

FIG. 1 shows the process in which the chosen fluidizing gas or air is injected at 3 into a wind box placed beneath the bed. The air then passes through a porous element, or a grid or a perforated metal plate, the head loss of which is chosen so as to fluidize the powder correctly. The pump is shown at 1, the tribocharging tube is shown at 2 and the fluidized bed is shown at 4.

FIG. 2 shows one embodiment of the electrodes in the oven. 1 is the electrical supply, 2 the ceramic insulator, 3 a copper needle, 4 the electrical connection via a copper cable, 5 a copper tube and 6 the oven.

### DETAILED DESCRIPTION OF THE INVENTION

The objects that can be coated may be of any kind provided that they can be plunged into the fluidization tank and withstand the temperature of the oven. By way of example, mention may be made of metals such as aluminium, aluminium alloys, steel and its alloys.

As far as the powders are concerned, these consist of a substance which, through heating, will form a film to protect the object. By way of example, mention may be made of polyamides, polyolefins, epoxies and polyesters.

Polyamides are to be understood as meaning the products of condensation:
of one or more amino acids, such as aminocaproic acids, 7-aminoheptanoic acid, 11-aminoundecanoic acid and 12-aminododecanoic acid, or of one or more lactams, such as caprolactam, oenantholactam and lauryllactam;
of one or more salts or mixtures of diamines such as hexamethylenediamine, dodecamethylenediamine, metaxylyenediamine, bis(p-aminocyclohexyl)methane and trimethylhexamethylenediamine with diacids such as isophthalic acid, terephthalic acid, adipic acid, azelaic acid, suberic acid, sebacic acid and dodecanedicarboxylic acid;
or mixtures of all these monomers which lead to copolyamides.

Polyolefins are understood as meaning polymers comprising olefin units such as, for example, units of ethylene, propylene, 1-butene, etc.

By way of example, mention may be made of:
polyethylene, polypropylene, copolymers of ethylene with alpha-olefins, it being possible for these products to be grafted by unsaturated carboxylic acid anhydrides such as maleic anhydride or unsaturated epoxides such as glycidyl methacrylate;
copolymers of ethylene with at least one product chosen from (i) unsaturated carboxylic acids, their salts, their esters, (ii) the vinyl esters of saturated carboxylic acids, (iii) unsaturated dicarboxylic acids, their salts, their esters, their semi-esters, their anhydrides, (iv) unsaturated epoxides, it being possible for these ethylene copolymers to be grafted by unsaturated dicarboxylic acid anhydrides or unsaturated epoxides.

Particularly preferred substances are nylon-11 and nylon-12. The powder size is advantageously between 0.01 mm and 1 mm.

A “thin layer of powder” is to be understood as meaning a thickness of up to 2 mm and advantageously of between 0.1 and 0.6 mm.

The fluidized bed is sized in such a way as to completely immerse the article to be covered. Its shape is of little importance provided it contains the necessary volume of powder, and provided that the item to be covered can be completely immersed and that fluidization is correct.

With regard to the forced-circulation tribocharging device and firstly the material that will tribocharge the powder correctly, an initial choice may be made by comparing the work functions of the powder and of the envisaged material. This can be done by looking at the values of the work functions in electron volts of the two species in question and by looking at their respective positions in a triboelectric series. The greater the difference: |Wf_{powder}/Wfₘₐₜₑᵣᵢₐₗ|, the more readily the powder will charge. It is recommended that this value be greater than 0.5 eV in absolute value. “Wf” denotes the work function; these values are read from triboelectric series tables such as, for example, ELECTROSTATICS by J. A. CROSS, IOP Publishing, 1987. Lower values may be considered, in the sure knowledge that the tribocharge will consequently not be as good and the coverage therefore less effective.

However, these values are merely theoretical and the fact that a good tribocharge is obtained between the material and the powder may be verified by performing the experiment described by I. I. Inculet et al. in patent U.S. Pat. No. 5,289,922 and which consists in tribocharging the powder in a rotating cylinder made of the tribocharging material and then measuring the charge obtained. Using this type of test, if the ratio Q/m (specific charge) obtained with the powder is higher, in absolute value, than 0.5×10⁻⁶ C/kg then the charge per unit volume that will be obtained in a bed larger than the object to be coated will be high enough. It is always possible to test out materials which give lower values in the certain knowledge that the coverage will be thereby affected. By way of examples, of tribocharging materials, mention may be made of PVC, PTFE, PVDF and stainless steel.

The powder is charged by triboelectrification, that is to say by friction or contact with a material which is a good tribocharger. The tribocharging material is chosen according to the criteria defined above. If the powder to be charged is a polyamide, the tribocharging material is advantageously PTFE (polytetrafluoroethylene). This tribocharging principle is known per se, and is used in the tribocharging guns of the prior art.

Advantageously, some of the powder and some of the gas of the fluidized bed is drawn off and forced to pass through tubes of the tribocharging material and returned to the fluidized bed, where it remixes with the powder present in the bed. It is unnecessary to pass all of the gas and powder of the fluidized bed through the tubes of the tribocharging material. The flow of gas containing the powder that is forced to pass through the tubes of the tribocharging material may be from 0.5 to 20%, and advantageously from 1 to 10%, of the fluidizing gas flow. This flow of gas containing the powder that is made to pass through the tubes of the tribocharging material may also be defined by its hourly volume, which is a function of the volume of the fluidized bed. This fraction may take any value, but advantageously it is from 0.5 to 30% of the volume of the fluidized bed. So as to be able to have the maximum amount of powder/tribocharging material contacts, the tubes of the tribocharging material may be placed in a spiral around a cylindrical element. Inside the tubes charges are created, due to the triboelectrification between the powder and the tribocharging material. A person skilled in the art may adjust the flow rate of gas laden with powder through the tribocharging device, observing the amount of powder which is deposited on the object to be coated, which is dipped into the bed.

The tubes making up the tribocharging material may, for example, have a length of between 1 and 6 mm and a diameter of between 4 and 15 mm, advantageously between 4 and 8 mm. Since the tubes have a relatively small diameter, there will be very many powder/tribocharging material contacts and the triboelectrification will be all the better. Likewise, the triboelectrification will be all the better the longer the tubes of tribocharging material.

It is recommended to remove the charges which are generated by the triboelectrification and which are inside the Teflon tubes. To do this, the same principle as that used in a tribogun (or tribocharging gun) is used. There are several solutions for removing these charges. Advantageously, the outside of the tubes making up the tribocharging material is covered with a conductive paint. After three or four hours of operation, the charges build up. This build-up creates a discharge which results in the appearance of a conductive carbonized part, allowing the charges to be removed. Charges develop inside the tubes made of tribocharging material. After three or four hours of operation, sparks appear and a “breakdown” occurs. This breakdown shows that a conductive part between the inside (which is nonconducting) and the outside (which is conducting) of the tubes appears. The charges can then flow away through this conductive part.

Advantageously, the conductive parts are created “artificially” by making a hole in the tribocharging tube with a needle. This hole is covered with a layer of nickel-based conductive paint. Holes may be made every 10 or 30 cm. The tube is then covered on the outside with Aquadag®, a conductive paint. It is also recommended to earth the cylindrical element around which the tribocharging tube is wound.

The means for causing this forced circulation is, for example, a pump or an equivalent device, such as a gas ejector (preferably operating with the same gas as the fluidized bed). On leaving the tribocharging device, the gas and the charged powder are remixed with the fluidized bed. This forced-circulation tribocharging device may be placed inside the fluidized bed, but there is a risk of disturbing the operation of the bed. In addition, it is necessary to electrically isolate the tribocharging tubes from the fluidized bed by covering them with rubber or with an insulation, while removing the charges from the tribocharging tube to the outside of the bed. It is very much simpler for this device to be on the outside of the bed. The pump (or the forced circulation means) sucks up the powder and the gas via tubes which pass through the wall of the fluidized bed and sends them into the tribocharging tube (or tubes) and then, via another orifice pierced in the wall of the fluidized bed, returns the powder and the gas to the bed. The pump may be replaced with a gas ejector preferably operating with the same gas as that which is in the fluidized bed. The withdrawal from the fluidized bed of the powder-laden gas and its return to the bed after having passed through the tribocharging tubes must be accomplished as far as possible without disturbing the fluidization and therefore the deposition of powder on the object to be coated. For example, it is possible to use low rates of flow through the tribocharging tube, to place one or more compartments in the fluidized bed or else to effect the return to the fluidized bed via a system of cyclones and/or compartments.

The electric charge on the powder of the fluidized bed increases with the flow rate of powder through the tribocharging device. The thickness of the powder layer on the object immersed in the fluidized bed increases with the electric charge on the powder.

The conditions of operating the fluidized bed are known per se—these are standard conditions and are described in the prior art.

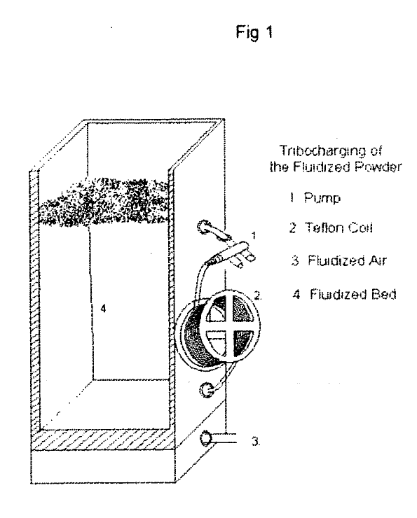

FIG. 1 shows one embodiment of the invention. As may be seen in FIG. 1, the chosen fluidizing gas or air is injected at 3 into a wind box placed beneath the bed. The air then passes through a porous element, or a grid or a perforated metal plate, the head loss of which is chosen so as to fluidize the powder correctly. The pump is shown at 1, the tribocharging tube is shown at 2 (PTFE sold under the brand name TEFLON® by DuPont was used) and the fluidized bed is shown at 4.

According to another form of the invention, a surface pretreatment is given to the object before it is brought into the bed. This may be a conventional pretreatment used in the plastic-coating industry: phosphate plating, degreasing, shot peening, application of liquid or powder primer, etc. This list is not exhaustive. The objects that are to be covered are brought in by an earthed conveyor. The powder is then charged in the tribocharged bed described earlier. Electrodeposition occurs during dipping. It is important that the article be agitated in a sustained way to a greater or lesser extent according to the level of charge in the bed. This agitation may be performed by small hammers present on the conveyor or by any other system. A tapping system allows surplus powder to be removed as the object leaves the fluidized bed.

In the case of covering powders which require a primer, this primer may be applied to the object beforehand, before it is dipped in the tank of fluidized powder, and this primer may be a liquid or solid primer.

In the case of a solid primer, this may be applied by electrostatic powder coating, corona-effect spray gun, tribopowder coating or both. It is also possible to apply the primer using a tribocharged bed. The primer particles are of very small size and the primer cannot therefore be fluidized on its own. However, if the primer is mixed, in a first bed, with the powder with which the object is to be covered, using a primer content of at least 1% by weight (compared with the weight of powder) and preferably of 5 to 10% by weight, then the small primer particles can be fluidized by the large particles of fluidization powder. This first tribocharged bed is of the same type as those described previously. The charge acquired by a particle is more or less inversely proportional to its radius. The small, more highly charged primer particles will therefore constitute most of the electrodeposit. The object will thus have been coated with a solid primer. The object is then coated with a second coat in a tribocharged bed containing the coating powder alone. During operations with primer it is possible, if desired, for this primer to undergo a first baking; it is also possible to avoid this intermediate baking and carry out the second covering operation and then carry out an overall bake.

Once the object has been covered in the bed, it is conveyed into an oven where baking takes place. Depending on the geometry of the object, the properties of the powder and the desired production rate, it is possible to use either a convection, infrared or induction oven. This step of the method is known per se and has already been described in the prior art.

According to an advantageous embodiment of the invention, the oven includes electrodes raised to a high electrical potential so as to cause a corona effect which compensates for the relaxation of the charge on the powder particles while they are being heated. The charge on the particles is thus maintained and therefore they remain on the object and can thus form the film by melting. This method is particularly useful when there is no primer on the object to be coated.

A system for generating a space charge is placed inside the baking oven so as to prevent the powder from becoming detached from the metal components. This is because, with certain powders and with the increase in temperature, the relaxation time of the powder decreases and the powder becomes detached from the metal component. A system generating a charge of the same sign as that of the powder is put in place. To generate a space charge, an electrical potential is applied to a metal component isolated from earth. If this metal component contains pointed parts, a corona effect occurs. For example, in the case of an oven having the dimensions of 0.4×0.3×0.5 m, all that is required are four vertical copper tubes 1.2 cm in diameter placed on a metal plate inside, in the bottom part of the oven and in each corner. Each tube is plugged at its upper end by a convex rounded end so as to prevent the unnecessary corona effect. The corona effect must be concentrated at the needles mounted on the copper tubes. These needles are the cause of the corona effect. An electrical potential is applied to the metal component, which is insulated by high-temperature-resistant insulators (for example ceramic insulators).

The temperature is an important factor in the baking of a coating on an article. For example, nylon-11 melts at 186° C., and the temperature of the oven is adjusted to 220° C. The baking time varies depending on the temperature of the oven. This is because the higher the temperature of the oven the shorter the baking time of the article. For an oven temperature of 220° C. and a PA-11 powder, the baking time is generally between 6 and 10 minutes.

The higher the oven temperature the shorter the relaxation time of the charge on the powder, that is to say the powder discharges more quickly when the temperature increases.

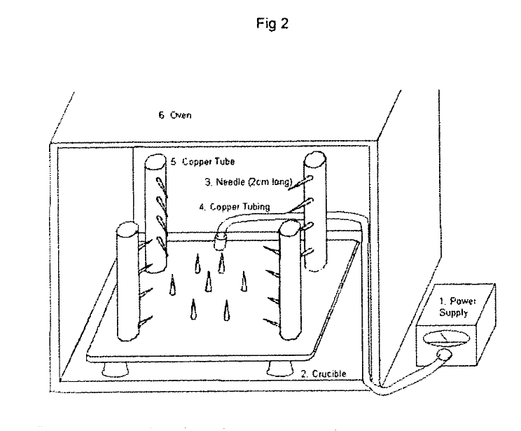

FIG. 2 shows one embodiment of the electrodes in the oven. 1 is the electrical supply, 2 the ceramic insulator, 3 a copper needle, 4 the electrical connection via a copper cable, 5 a copper tube and 6 the oven.

1. Method for covering an object with a film resulting from the melting of a thin layer of powder, in which method comprises:
(a) having a bed of electrified fluidized powder in a tank, this powder being charged by a forced-circulation tribocharging device;
(b) dipping the object, connected to zero or sufficient potential, into the tank in order to cover it with powder;
(d) placing the object, covered with the powder, in an oven at a temperature high enough to obtain the coating film by melting the powder.

2. Method according to claim 1, in which the tribocharging device consists of tubes of tribocharging material supplied by a pump or a gas ejector.

3. Method according to claim 1, in which the forced-circulation tribocharging device is outside the tank of the fluidized bed.

4. Method according to claim 1, in which the length of the tubes of the tribocharging device is between 1 and 6 m.

5. Method according to claim 1, in which the diameter of the tubes of the tribocharging device is between 4 and 15 mm.

6. Method according to claim 5, in which the diameter of the tubes of the tribocharging device is between 4 and 8 mm.

7. Method according to claim 1, in which the oven includes electrodes raised to a high electrical potential so as to cause a corona effect, which compensates for the relaxation of the charge on the powder particles while they are being heated.
